(19) United States
(12) Patent Application Publication
(10) Pub. No.: US 2014/0363253 A1
(43) Pub. Date: Dec. 11, 2014

(54) Sling It

(71) Applicant: Cindy Bedient, Amargosa, NV (US)

(72) Inventor: Cindy Bedient, Amargosa, NV (US)

(21) Appl. No.: 13/914,267

(22) Filed: Jun. 10, 2013

(51) Int. Cl. B60P 7/08

(52) U.S. Cl. CPC B60P 7/0823
USPC 410/101

(57) ABSTRACT

The Sling It is a tie-down device with a center portion which can open up in accordion fashion to better conform to the material it is securing. When not in use, or the restrained item does not require use of the conforming central section of the Sling It, the center section collapses so that it can be easily stored, or used as a simple strap.

### CROSS-REFERENCE TO RELATED APPLICATIONS

This application is a continuation of application Ser. No. 12/324,135, filed Sep. 21, 2010, which claimed the benefit of U.S. Provisional Application No. 61/277,522, filed Sep. 24, 2009. Each patent application identified above is incorporated here by reference in its entirety to provide continuity of disclosures.

### STATEMENT REGARDING FEDERALLY SPONSORED RESEARCH OR DEVELOPMENT

Not Applicable.

### REFERENCE TO SEQUENCE LISTING, A TABLE, OR A COMPUTER PROGRAM LISTING COMPACT DISC APPENDIX

Not Applicable.

### BACKGROUND OF THE INVENTION

The present invention relates to strap and rope systems, particularly those used to secure packages to vehicles for storage, transportation, and/or other uses.

Packages are often secured to vehicles, especially the beds of pick-up trucks, with thin straps or holddowns that, while flexible, only provide limited contact with the item. The choices users face are to use additional packing material, additional straps, or a combination of the two. The Sling It uses an expanding center portion to conform to a load, allowing greater contact with the item.

### BRIEF SUMMARY OF THE INVENTION

This invention addresses the need to secure items of variable shapes with one securing item. This one strap can be used to secure either one item or several, in the place of several straps at various angles. The one strap can expand in an accordion fashion, secured only on the ends, to secure various shaped items better, and avoid items being dislodged in transit. When not in use in the expanded accordion stage, the strap can be collapsed to function as a simple strap, or for storage. Thus, one strap can do the job of several, and better than several when the issues of storage is concerned.

### BRIEF DESCRIPTION OF THE SEVERAL VIEWS OF THE DRAWING

With the above in mind, the invention consists of the a combination of parts, as more fully understood from the following description, when read in conjunction with the accompanying drawings, in which the view represents a perspective view of the present invention.

FIG. 1. is a perspective view of the Sling It, with the central portion completely unfolded, i.e. “open.”

FIG. 2. is a perspective view of the Sling It, with the central portion folded. i.e. “closed” in a strap like configuration.

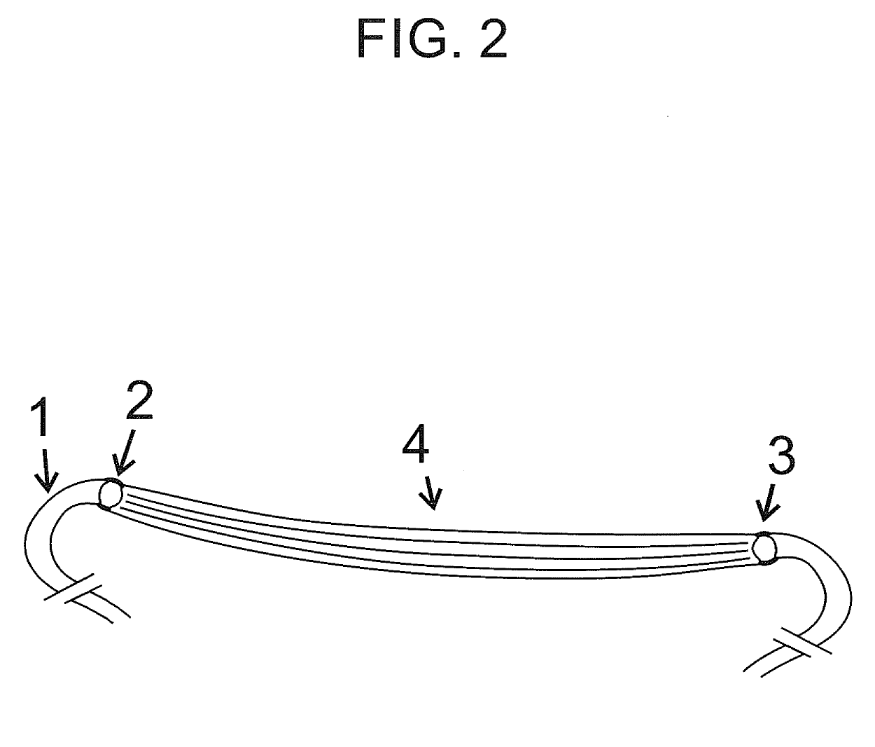

FIG. 3. is a detailed view of the connection of the center portion to the ring, which connects to the straps.

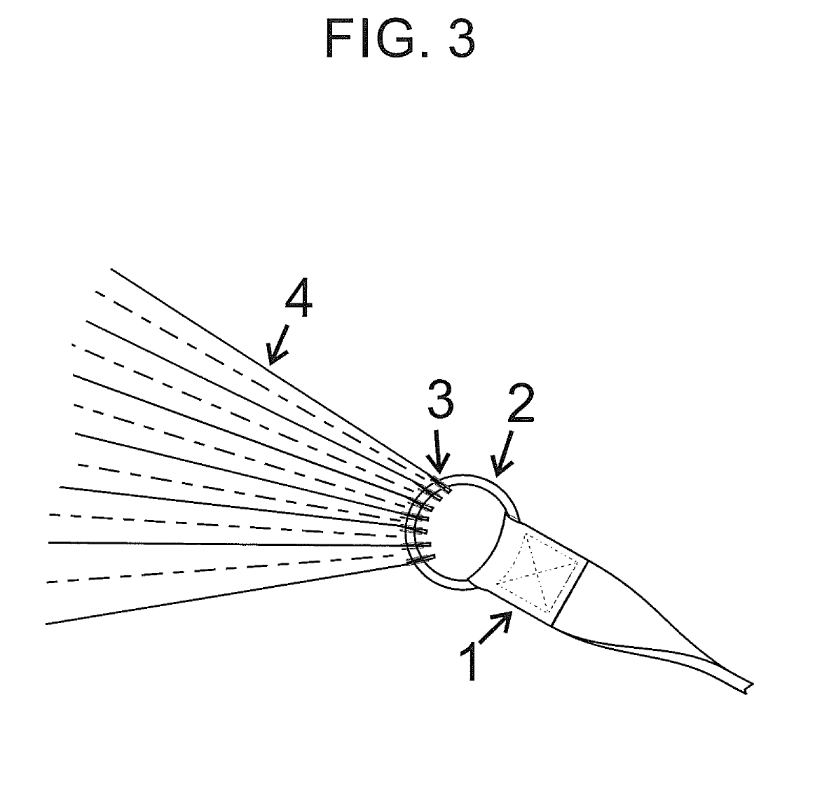

FIG. 4. is a perspective view Sling It, partially open, emphasizing the relation of the O-ring to the center portion, allowing the expanding and contracting of the center portion between “open” and “close” configurations.

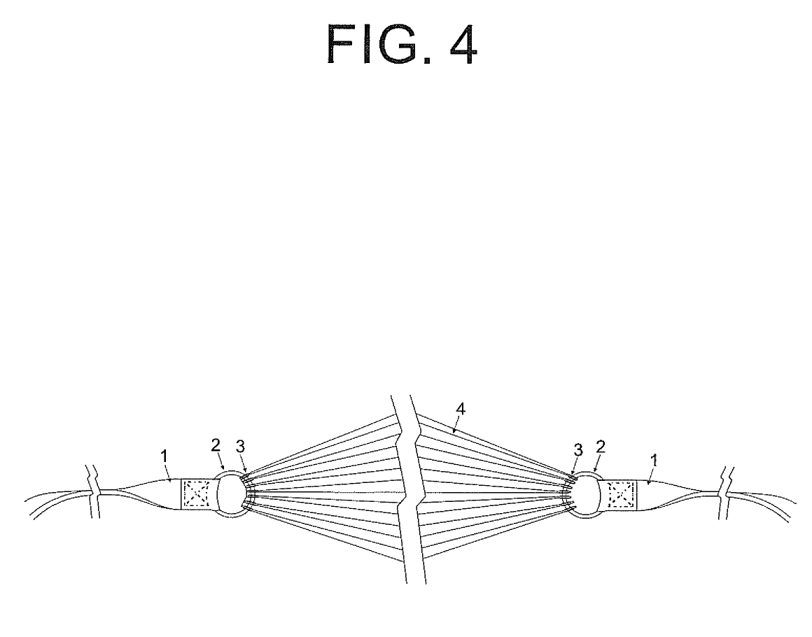

FIG. 5. is an embodiment view of the Sling It restraining an irregularly shaped object in a trailer

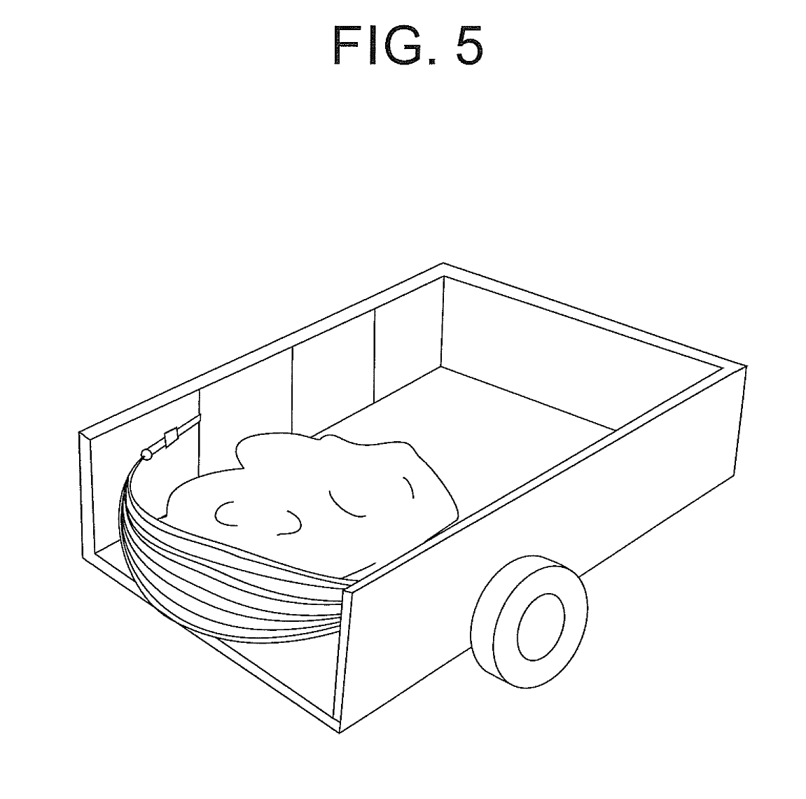

### DETAILED DESCRIPTION OF THE INVENTION

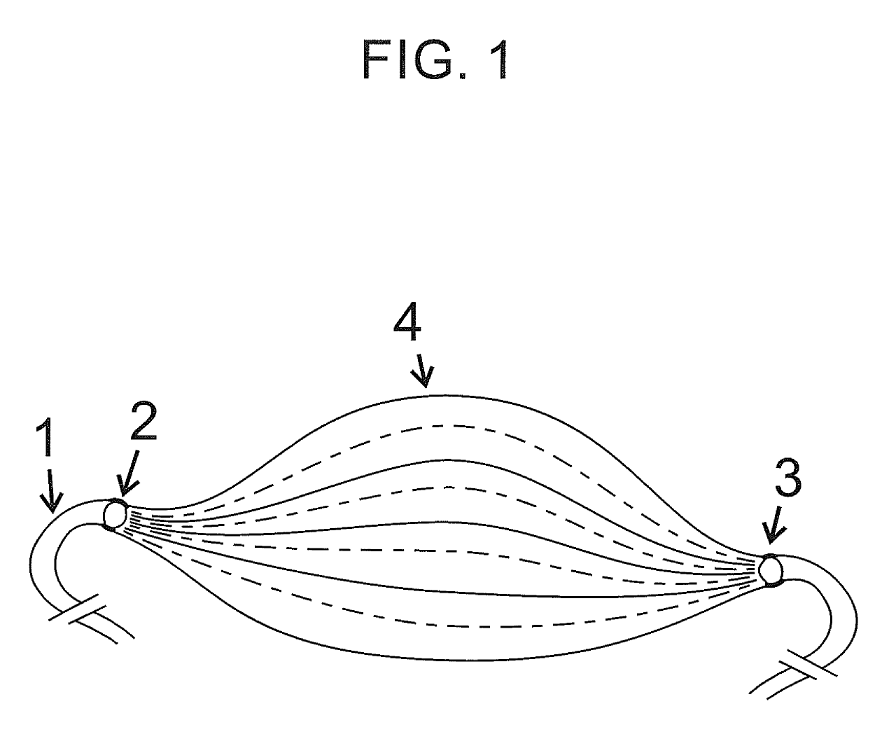

The preferred embodiment, as seen by reference to FIG. 1, includes a center portion, also referred to as a main body, of the Sling It which conforms to the shape of the item being held by the Sling It, and is generally referred to with the numeral 1. This center portion is composed of material which is folded along the longitudinal axis in such a manner as to allow the center portion to expand along the latitudinal axis, forming a roughly oblong shape. When the Sling It's central portion is not expanded, the central portion is folded along the longitudinal folds, resulting in the center portion being able to lay in a roughly flat, strap-like configuration. On both sides of the center portion are straps 2, which can be adjusted in length, and which can have the tension on these variable sized straps adjusted by means of a separate ratcheting device. These two straps are called the variable length straps. The variable length side straps are used to adjust the overall length of the Sling It based on determination of the user of the ideal position of the central portion of the Sling It. The central portion 1 will be composed of a durable material, attaching by grommets in the material of the center portion 4 to a brass or stainless steel O-rings 3 which are then attached to straps composed of the same material as the middle section. These variable length straps are one inch in width, and variable only in length. The Sling It can be used in either of two configurations. In the first configuration, the center portion has been expanded along the latitudinal axis by way of opening the previously folded material. In the second configuration, the center portion material has not been expanded, and remains folded by the longitudinal folds.

The main body of the Sling It consists of a strong heavy threaded cloth material, similar to a canvas material, that is 50 inches in length and 21.5 inches in width. This center portion is sewn along the outside length so as to have a 1 inch hem along the 21.5 inch side, and along the 50 inch width with a 0.25 inch hem. The material is then folded length wise and pressed into 1.5 inch folds, totaling 14 sides, to make the material into a 1.5 inch wide strip when folded. The length ends, containing the 1 inch hem, then has the 7 folds Grommeted together by 2 sides at each fold so as to make 7 Grommets at each 21.5 inch end. Each side having the longer 50 inch edges with folds between each side, and the shorter edges with a Grommet attachment of two sides in an alternating fashion. Then a strong 1.25 inch O-ring, split open to allow the affixing of the Grommeted portion of the center portion, is threaded through the Grommets and then fixed into a ring shape. An O-ring is preferred over a D-ring due to bunching up of the material composing the center portion and the variable straps. A 48 inch strap is connected and stitched to the other side of each O-ring, opposite of where the internal section connects to the O-ring. The material composing the internal section then opens to a fitted tie-down.

### SEQUENCE LISTING

Not Applicable.

I claim:

1. A device for securing an item, said apparatus comprising:
Two straps of nylon or canvas material which are as rigid or more rigid than a center portion;
said straps flanking the center portion and said straps being the only portion of the device capable of attachment to a securing device;
with said center portion being made of a nylon or canvas material capable of expanding by way of a process of set folds which allow the material comprising the center portion to conform to an item being secured by the device;
with said center portion attached to O-rings;
with said center portion also capable of being refolded by reversing the expansion of the folds, allowing the center portion to return to a compacted shape similar to that of the flanking straps of durable material.

2. The device of claim 1, where the center portion is attached at multiple points by way of Grommeted attachment means to two O-Rings, said O-rings being less than 2 in. in diameter, which are then attached only to the two straps of nylon or canvas material.

3. The device of claim 1, where the straps of nylon or canvas material are capable of being set in a variable or fixed tension device.

4. The device of claim 1, where the straps of nylon or canvas material are the only members by which the device is attached to a securing device.
